(19) United States
(12) Patent Application Publication
(10) Pub. No.: US 2003/0174169 A1
(43) Pub. Date: Sep. 18, 2003

(54) Porting screens designed for a higher resolution HMI to a lower resolution HMI

(76) Inventors: Rajesh K. Tiwari, Carol Stream, IL (US); Umesh K. Gupta, Davenport, IA (US); Sankaranarayanan R. Krishnamoorthy, Carol Stream, IL (US)

Correspondence Address: Rajesh K. Tiwari, 363 ST. PAUL BLVD., CAROL STREAM, IL, 60188, US

(21) Appl. No.: 10/354,639

(22) Filed: Jan. 30, 2003

Related U.S. Application Data
(60) Provisional application No. 60/353,892, filed on Jan. 31, 2002.

(51) Int. Cl. G09G 5/00

(52) U.S. Cl. 345/764

(57) ABSTRACT

An operator Interface panel with procedure to port screens or video pages designed for a higher resolution panel to a lower resolution panel of the said panel type is described to save development time.

### BACKGROUND

1. Field of Invention

This invention relates to HMIs, (an acronym for Human Machine Interface), specifically to method for porting HMI screens designed for a higher resolution HMI to a lower resolution HMI.

2. Discussion of Prior Art

The HMIs are also known as Touch Panels, Touch Screens, Man Machine Interfaces (MMI) and Operator interface panels. In this document, HMI and Operator interface panels are used synonymously. The discussion in this document excludes software-based HMIs that run on a PC or a general-purpose computer. This document covers electronic operator interface panels with a dedicated microprocessor

In many cases Electronic Operator interface panels or HMIs replace much of the hardwired control components from an automation panel, such as Push Button, Indicator Lights, Pilot Lights, Meters, etc. The recent trend in industrial automation shows an increased use of HMI's. The reasons for this trend are:

1. HMIs save premium panel space.

2. HMIs are cost effective alternative to hardwired control components.

3. Automation panels using HMI can easily be reconfigured as compared to the ones using hardwired controls.

4. Control components can easily be added or deleted from HMI screens as compared to adding/deleting hardwired components from the panel.

5. HMIs offer much more than push buttons and pilot lights. For example, the modern HMIs will allow you to use Bar graphs, Trend Graphs, Alarm capabilities, etc., on screens.

Video Pages or screens for a panel are designed using a programming device, typically a PC, running a page-design software specific to the panel. Video pages and screens are used here synonymously.

OEMs typically offer the option of different HMI screen sizes to their customers. For example on the same machine a user may have option to buy a larger HMI (higher resolution, larger screen size) or a smaller HMI (smaller resolution, smaller screen). For example a machine may have option to use a 10″, 640×480 pixel resolution screen, or a 6″, 320×240 pixel resolution screen. Though the HMI sizes vary, the functional requirements of the HMI for a machine remain the same. Ideally, the OEM would develop HMI user program (the HMI screen designs) just once, and use them on both the larger & the smaller size HMI's. But usually this is not the case. Since larger HMI offers more space, more objects are placed on the HMI with larger screen. The screens designed for a larger HMI would not fit within the display-resolution of the smaller HMI. One solution is to automatically proportionally scale the objects whenever the screen size of a project (screen designs) is changed. For example if an OEM design screens for a 640×480 pixel unit, and then use the same designs for a 320×240 pixel unit, we can scale all the objects by ½ (in length as well in width). This approach will make all the objects fit on the smaller screen automatically. The approach, in theory, appears straightforward, and desirable, as the OEMs would have to design the screens only once, and freely switch the display sizes. Practically, this approach has severe limitations. The scaled objects may become too small or too large to be of any use. Text, which usually is not as much scalable on HMIs, may run outside the boundaries of objects. In all probability the designer has to go back and resize and move practically all the objects on all the screens. This invention, instead of scaling the objects automatically when user switches display resolution, points out to users the screens of their project that have objects outside the boundaries of the lower resolution screen, as well as provides a visual help to locate the objects within the boundary of lower resolution screen, making porting screens easier.

### OBJECTS AND ADVANTAGES

The object of this invention is to provide a simple way to help port screens or video pages meant for a higher resolution HMI to a lower resolution HMI. The advantage of the invention is to save time by providing help in porting the video pages.

### SUMMARY

The invention helps users to easily port HMI screens designed for a higher resolution display to a lower resolution HMI unit. The invention is implemented for porting screens designed for 640×480 pixels display to a 320×240 pixel display. But the idea is applicable for other resolutions. This invention provides users information so that they know which screens have objects outside the boundaries of the lower resolution HMI, as well as provides a visual help to locate the objects within the boundary of lower resolution HMI.

### DRAWINGS

FIG. 1—shows a block diagram of a control system showing an HMI.

FIG. 2—illustrates the HMIs with different display resolutions.

FIG. 3—shows a flow chart outlining the procedure to detect the screens where objects are outside the boundary of lower resolution HMI.

FIG. 4—illustrates the visual help in identifying the boundary of the lower resolution screen within the higher resolution screen.

### DESCRIPTION

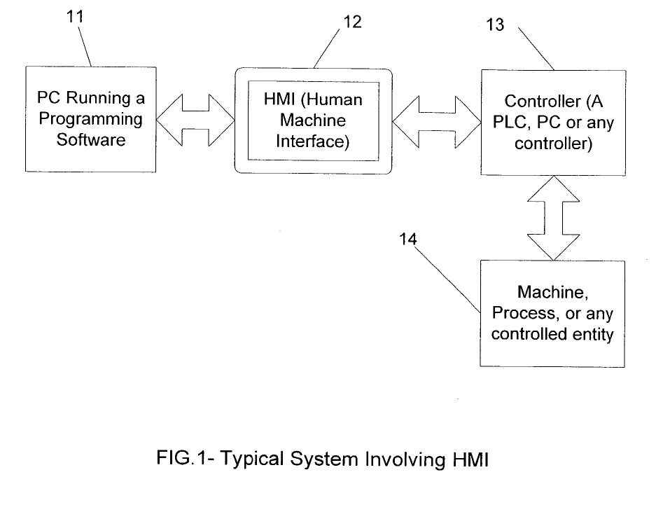

FIG. 1 shows a block diagram showing major components of a control system that uses HMI. It shows a PC 11 that is used to design screens for HMI 12. HMI 12 communicates with controller 13, which in turn controls a machine or process 14.

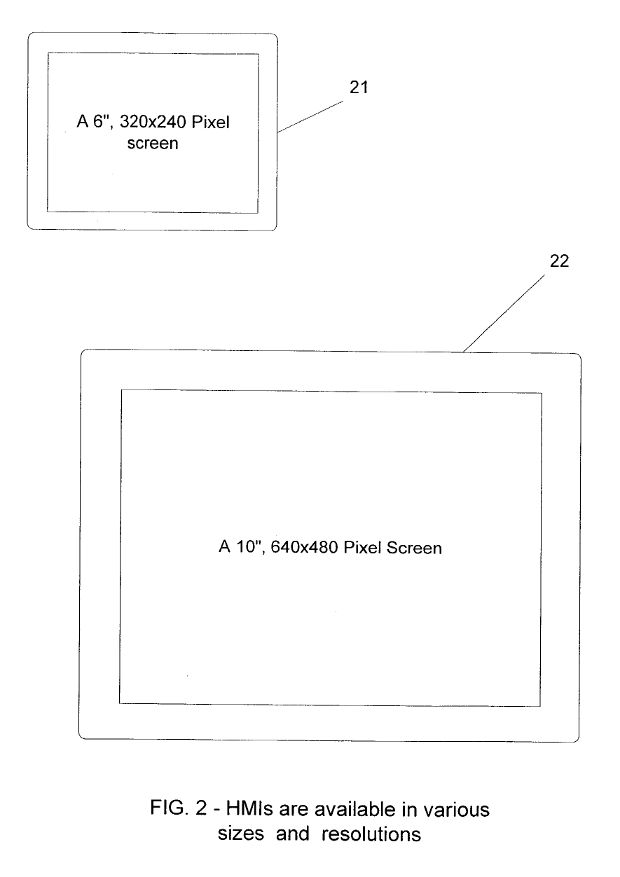

FIG. 2 shows two display resolutions commonly used for HMIs. The figure shows HMI with display resolution of 320×240 (21) and another with display resolution 640×480 (22). Although the diagonal dimensions mentioned in the figure are 6″ (21) and 10″ (22), these vary widely. For example displays with less than 8″ diagonal may have resolution of 640×480. In other words, the dimensions & resolution are for illustrations only; the concept is useful with any two differing resolutions.

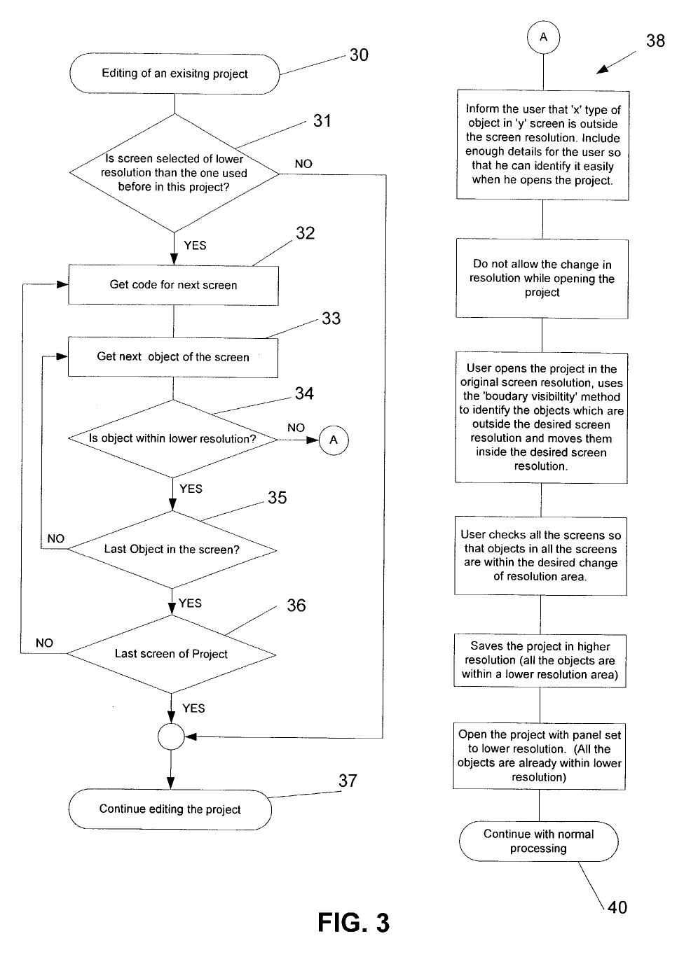

FIG. 3 shows a flow chart. The flow chart outlines a procedure to be followed whenever user selects a display resolution (320×240 in this case) for a project that was designed for a larger resolution display (640×480 in this case).

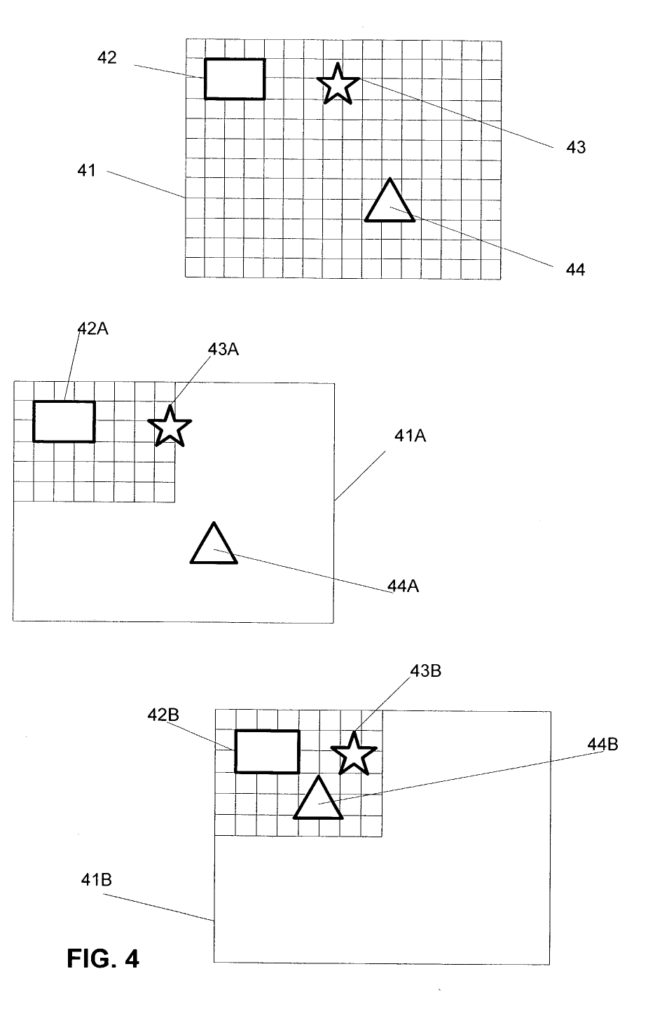

FIG. 4 shows a display 41 with 640×480 pixel resolution

### OPERATION

The invention is useful when a user wants to port screens designed for a larger resolution HMI to a lower resolution HMI. The invention helps users to port these screens easily by providing following information/help:

1. Which screen design has objects lying outside the boundary of lower resolution display?

2. Show on a larger screen the boundary of a smaller resolution screen so that the user can easily move objects within this boundary without any guesswork.

These two together makes porting of screens from higher resolution of display to a lower resolution HMI easier.

FIG. 3 shows a flow chart for the relevant part of an HMI editor, which will detect the objects outside the lower resolution HMI display boundary.

As block 30 indicates, when the user edits an existing project, the selected HMI's resolution is compared to the resolution used before in the project (31). If the resolution is the same nothing needs to be done, and processing continues as usual (37). If the new resolution is lower, then, the project's code is read, and for each screen (32), and for each object (33) on the screen, a check is made to see if the object lies within the boundaries of low-resolution HMI (34) (320×240 in this implementation). This is repeated for all objects in the current screens, and all screens in the project (35, 36). If an object is found which is outside the display boundary, a message is given to user to this effect (38) providing enough information to the user (for example, screen number, name and object type that is outside the boundary). The user would then open project in it's original resolution, and use the visual aid shown in FIG. 4. The user is not allowed in this case to select a HMI with lower resolution as a target HMI, until all objects of the project are within the selected HMI's display size. Once the user moves all objects within the lower resolution, then only the screen design software allows the user to switch the target HMI to a lower resolution.

A visual aid is provided to the user to help him/her move objects within the smaller display by indicating the smaller screen within the larger screen. FIG. 4 shows a 640×480 pixel screen (41) with 3 objects (42, 43, and 44) on it. On selecting “Show 320×240 Screen”, the grid is displayed only within the 320×240 pixels (41A). The user can clearly see where the display boundary is for the smaller HMI screen, and which objects are going to be outside the display boundary if the current screen was ported to lower resolution HMI. In the FIG. 4, object 43A is partly inside, while object 44A is completely outside. User can move then these objects within the grid as shown in 41B (objects 43B, 44B). This visual aid takes any guesswork out, and therefore any trial and error.

Included CD has a screen design software, called PowerPanel Programming software. The software runs on a PC running Windows 98, NT, 2000 or XP operating system with at least 800×600 screen resolution. To install the software follow the instructions given below:

1. The CD has an auto run feature, i.e. once you insert the CD, it would automatically run the setup program to install the screen design software. Follow on screen instructions to install the software.

2. If for any reason, the CD does not auto run, please explore the CD, Find Setup.exe file and run it. Follow on screen instruction to complete the installation.

To see how this feature work, start a new project, select a higher resolution HMI for target HMI (640×480), then design at least one screen. Keep the objects distributed all over the screen. Now close the project and re-open it and select a lower resolution HMI (320×240) as a target HMI. The software will go through the process described above.

We claim:

1. An operator interface panel with means to electrically connect to a machine controller and having means to connect to a programming device having multiple video pages, each said page having objects that provide operator input to the machine and/or machine status to the operator, with means to aid porting of programmed video pages meant for a higher resolution panel of the said operator panel type, to a lower resolution panel of the said operator panel type.

2. The Operator interface panel of claim 1 having means to display said video pages on a graphical display comprising of a liquid crystal display or a plasma display or a cathode ray tube.

3. The Operator interface panel of claim 2 having electrical and mechanical means to connect a touch screen to the said graphical display, said touch screen allowing operator input to the machine by touching said objects.

4. Operator interface panel of claim 1 wherein the said programming device comprising of a PC and Programming software with means of detecting resolution of said operator panel.

5. Operator interface panel of claim 4 with the said programming device having means to not to write video pages to said operator panel if the resolution of said video pages does not match with the resolution of said operator panel.

6. Operator interface panel of claim 4 with said programming software having an icon and a menu item that would display a rectangle corresponding to a lower resolution panel within a rectangle corresponding to a higher resolution panel.

7. A method to port video pages designed for an operator interface panel, comprising:
a. Providing a programming device comprising of a PC and a software,
b. Providing an icon and a menu item in the said software,
c. Displaying a rectangle corresponding to a lower resolution panel within a larger rectangle corresponding to a higher resolution panel to guide users to place all graphics within the smaller rectangle.
